(19) United States
(12) Patent Application Publication
(10) Pub. No.: US 2009/0144181 A1
(43) Pub. Date: Jun. 4, 2009

(54) Method and apparatus for providing task related navigation services

(76) Inventor: Ananth Rani, Fremont, CA (US)

Correspondence Address: RAYMOND R. MOSER JR., ESQ.;MOSER IP LAW GROUP, 1030 BROAD STREET, 2ND FLOOR, SHREWSBURY, NJ, 07702, US

(21) Appl. No.: 12/291,169

(22) Filed: Nov. 6, 2008

Related U.S. Application Data
(60) Provisional application No. 61/001,970, filed on Nov. 6, 2007.

(51) Int. Cl. G06Q 10/00; G01C 21/36

(52) U.S. Cl. 705/32; 701/200; 701/201

(57) ABSTRACT

A method and apparatus for task based navigation by determining a task; determining a present location of a receiver associated with a user to perform the task; generating turn-by-turn travel information related to the task, where the turn-by-turn travel information indicates a path from the present location of the receiver to a location at which the task is to be performed; and transmitting the task and the turn-by-turn travel information to the receiver.

### CROSS-REFERENCE TO RELATED APPLICATIONS

This application claims benefit of U.S. Provisional Patent Application Ser. No. 61/001,970, filed Nov. 6, 2007, which is herein incorporated by reference.

### BACKGROUND OF THE INVENTION

1. Field of the Invention

Embodiments of the invention generally relate to location based services and, more particularly, to method and apparatus for providing task related navigation services.

2. Description of the Related Art

In many businesses, it is often required to locate the various resources that are used for performing various tasks. Typically, non-human resources are located using various methods, such as radio frequency sensors, tracking software, etc. For personnel such as, employees, service personnel, contractors and the like, other tracking systems are used such as identification badges, time entry systems and the like.

In general, identification badges and/or time entry devices are hugely dependent on human intervention. For example, when an employee enters an office premise, he/she is often required to swipe an identification badge. Upon swiping, a central tracking unit registers the entry of the employee, often known as the “clock-in time” into the premises/job. Similarly, when the employee is leaving the company's premises, the identification badge is swiped again to register the departure, often known as the “clock-out time” of the employee from the premises/job.

Such a system is solely dependent on the action performed by the employee. The action of swiping the badge may sometimes be inadvertently forgotten by the employee and, thus, the event is unregistered. Consequently, such a system can lead to inaccuracies, record discrepancies, and can be costly both to the employer and to the employee.

When an employee is traveling for business or “on a job” outside of the office, it is difficult for such an employee to maintain working-hours records. In addition, when traveling to different locations, an employee may inefficiently spend time trying to locate a job location. Therefore, the working-hours may include excessive time that is not actually worked.

Therefore, there is a need for a method and apparatus for providing task related navigation to enable employees to efficiently travel from job-to-job to perform various tasks.

### SUMMARY

Embodiments of the present invention include a method and apparatus for task based navigation by determining a task; determining a present location of a receiver associated with a user to perform the task; generating turn-by-turn travel information related to the task, where the turn-by-turn travel information indicates a path from the present location of the receiver to a location at which the task is to be performed; and transmitting the task and the turn-by-turn travel information to the receiver.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram of a task-based navigation system in accordance with one or more embodiments of the invention;

FIG. 2 is a block diagram representation of one embodiment of a receiver system used in a task-based navigation system;

FIG. 3 is a flowchart of a method for presenting a turn-by-turn task instructions, according to an exemplary embodiment of the present invention; and

FIG. 4 is a flowchart of a method for determining the status of a receiver, according to an exemplary embodiment of the present invention.

### DETAILED DESCRIPTION

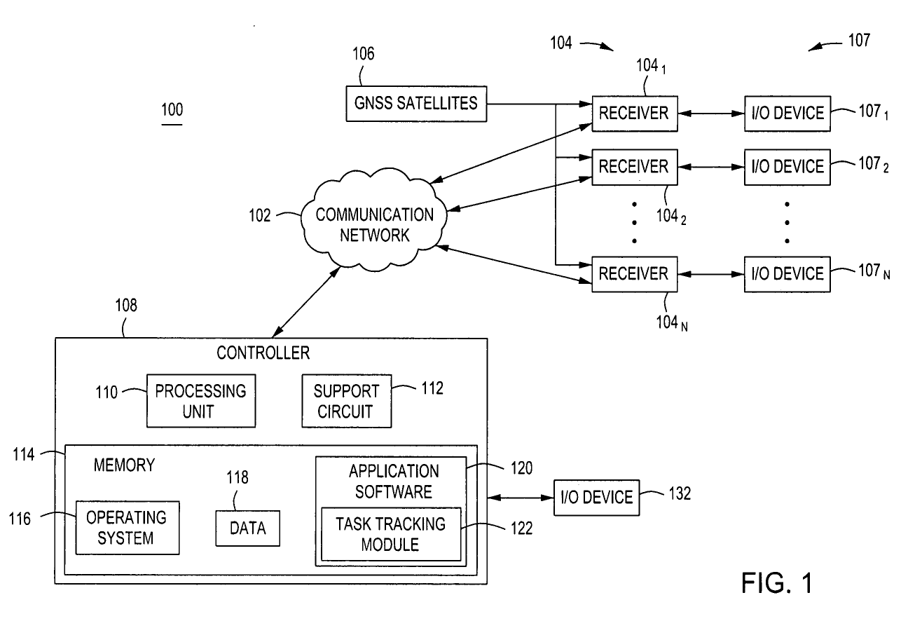

FIG. 1 is a block diagram of a task-based navigation system 100 in accordance with one or more embodiments of the invention. In one embodiment, the system 100 is designed to communicate and receive the location of personnel, such as employees, through a communication network. Each component of task-based navigation system 100 is described in further detail below.

In an illustrative embodiment, the task-based navigation system 100 is configured to provide turn-by-turn travel information (directions) to a user on a per task basis. The task-based navigator may also provide accurate hours worked relating to a specific employee and/or task. Those skilled in the art will appreciate that a task-based navigation system 100 may provide information to be used for business-related purposes, such as direction, specific task instructions, proof of an employee's visit to a job site, actual time spent at a job site, and the like.

The task-based navigation system 100 comprises a communication network 102, receivers 104₁, 104₂ . . . 104ₙ (collectively referred to as receiver 104), a network of Global Navigation Satellite System (GNSS) satellites 106 (e.g., Global Positioning System (GPS), Galileo, GLONASS, and the like), and a controller 108. The controller 108 communicates with the receiver 104 via the communication network 102. The communication network 102 may be a public and/or a private network, such as the Internet, a Local Area Network (LAN), Wide Area Network (WAN) and the like. In one embodiment, the receiver is a cell phone comprising a GNSS receiver and location based services software

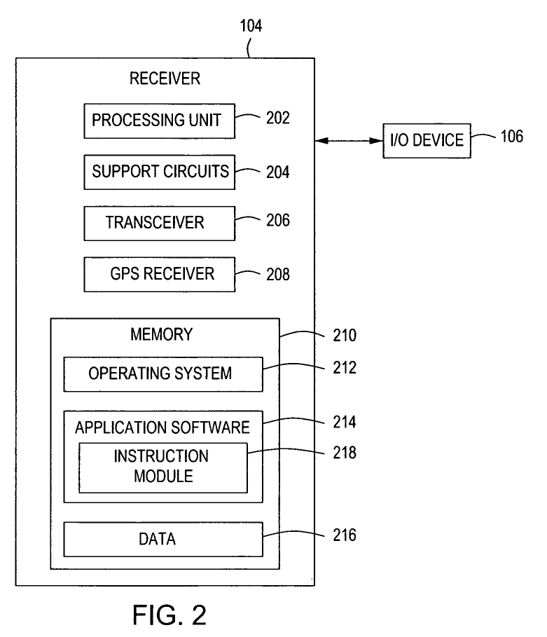

The receiver 104 utilizes the signals received from the GNSS satellites 106 for determining information relating to the location of the receiver 104. It should be noted that while the present invention is described as working with the communication network 102, alternative communication methods may be utilized. Typically, the receiver 104 communicates by wireless signals with the communication network 102. In one embodiment, the receiver 104 is a mobile device and/or a computer comprising GNSS receiver (shown in FIG. 2). In another embodiment, the receiver 104 is purpose built tracking device.

The GNSS satellites 106 may comprise one or more orbiting satellites. The orbiting satellites transmit radio signals. The GNSS satellites 106 is configured to provide GPS signals to at least one of the receivers 104. The GNSS satellites 106 may relay information that may include almanac data, absolute time data, and assistance data (may include satellite position information, such as ephemeris data or other type of satellite orbit model, expected code phase, expected Doppler and the like).

The receiver 104 may comprise electronic equipment that receives GPS signals from the GNSS satellites 106 for processing. According to one embodiment, the processing of the signal comprises decoding the satellite signals to recover satellite navigation data using decoding process known in the art. The receiver 104 may be hand-held GPS device, a GPS-enabled cellular telephone or personal digital assistant or a device mounted on a vehicle, or a device coupled to other devices such as a laptop computer, and the like. The receivers 104₁, 104₂ . . . 104n may be coupled to input-output (I/O) devices 107₁, 107₂ . . . 107ₙ (collectively referred to as I/O device 107). The I/O device 107 may be any device utilized to input data, to retrieve data from, or display data of the receiver 104, such as a mouse, key pad, monitor, and the like.

The controller 108 may be an electronic device such as a computer, a computer server, a mobile device or any such device known in the art. The controller 108 comprises at least one processing unit 110, support circuits 112 and memory 114. The processing unit 110 may comprise one or more conventionally available microprocessors. The support circuits 112 are well known circuits used to promote functionality of the processing unit 110. Such circuits include, but are not limited to, a cache, power supplies, clock circuits, I/O circuits and the like.

The memory 114 of the controller 108 may comprise random access memory, read only memory, removable disk memory, flash memory, and various combinations of these types of memory. The memory 114 is sometimes referred to as main memory and may, in part, be used as cache memory or buffer memory. The memory 114 generally stores the operating system 116. The operating system 116 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation, and the like.

In addition, the memory 114 may store data 118 and various forms of application software 120, such as, task tracking module 122. The data 118 may comprise a relational database, for example, SQL from Oracle Corporation. The data 118 may be utilized by the OS 116 and/or the application software 120. The controller 108 utilizes the task tracking module 122 to communicate and/or keep track of the receiver 104. The task tracking module 122 may utilize the data 118 and/or memory 114 to perform various tasks.

The controller 108 may be coupled to I/O device 132. The I/O device is utilized to input data, to retrieve data from, or display data of the controller 108. Such I/O device 132 may be, but is not limited to, a mouse, keyboard, monitor, CD-ROM, and the like.

In one embodiment, the receiver 104 is utilized by a user to retrieve turn-by-turn instructions for a task or a set of tasks. The turn-by-turn instructions may include driving directions, location information, map, service steps, or any general or special instructions that a user is to perform. The controller 108 configures and/or retrieves the turn-by-turn task instruction from the task tracking module 122. The controller 108 then transmits the turn-by-turn instructions to the receiver 104.

The system 100 tracks of the location of the receiver 104. Generally, the task tracking module 122 performs the remote tracking of the receiver 104. Thus, the task tracking module 122 is capable of determining if a receiver 104 is within the premises where a task needs to be performed, such as employer premises and the like. In one embodiment, the task tracking module 122 determines if an employee with a receiver 104 is clocked-in or clocked-out, depending on the location of the employee/receiver 104 in relation to the job location. As such, an employee whose receiver 104 is within the premises, or a specific distance there from, may be determined to be clocked-in. If the employee is not within the premises, such employee is determined to be clocked-out. The task monitoring module 122 may monitor the clock-in and clock-out of employee in various and remote locations. Such locations may vary day to day depending on the tasks assigned to the employee.

FIG. 2 is a block diagram representation of one embodiment of a receiver 104 used in a task-based navigation system. The receiver 104 includes a processing unit 202, support circuit 204, transceiver 206, GNSS receiver 208, and memory 210. The processing unit 202 may comprise one or more conventionally available microprocessors. The support circuits 204 are well known circuits used to promote functionality of the processing unit 202. The support circuits 204 may include conventional cache, power supplies, clock circuits, data registers, I/O circuitry and the like, in order to facilitate operation of the receiver 104.

The transceiver 206 is a combination of transmitter/receiver in a single package. The term transceiver may be used for wireless communications devices, such as, mobile phones, cordless telephone sets, handheld two-way radios, mobile two-way radios and the like. In one embodiment, the transceiver 206 is a GPS enabled mobile device, such as a mobile phone. The GNSS receiver 208 may include electronic equipment that receives Global Positioning System (GPS) signals for processing. Those skilled in the art will appreciate that the GNSS receiver 208 may be configured to compute the location of the receiver 200, to locate the receiver 200 on a map, and/or to provide directions to and from the receiver 104.

The memory 210 may be random access memory, read only memory, for example PROM, EPROM, EEPROM and the like, removable storage such as optical disk, tape drive and the like, hard disk storage, flash drives or any combination of such memory devices. The memory 210 may include an operating system (OS) 212, data 216 and application software 214. The operating system 212 may be one of a number of commercially available operating systems such as, but not limited to, SOLARIS from SUN Microsystems, Inc., AIX from IBM Inc., HP-UX from Hewlett Packard Corporation, LINUX from Red Hat Software, Windows 2000 from Microsoft Corporation, and the like. If the receiver 104 is a handheld wireless device, the Operating System (OS) 212 is a type that is supported by such a device. The data 216 may comprise a relational database, for example, SQL from Oracle Corporation. The data 216 may be utilized by the OS 212.

The application software 214 may include one or more applications executed/utilized by the receiver 104. The application software may include an instruction module 218 that may display location, retrieve location direction, report status, present task instruction and the like.

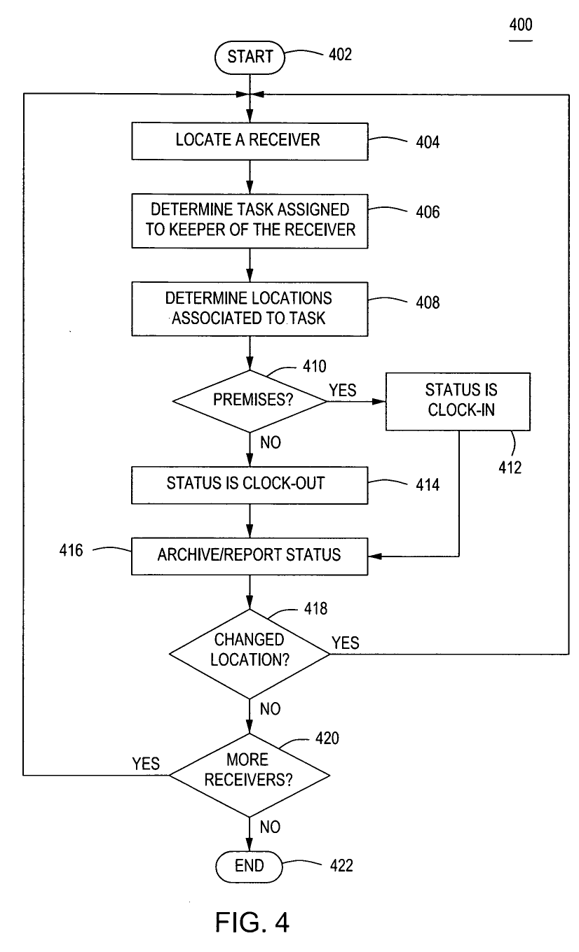

Upon receiving information related to the task, an employee proceeds to the job site. The exact location of the employee is provided to the controller 108 (shown in FIG. 1) via the GNSS receiver 208. In one embodiment, on entering the job site, the task-based navigation software application transmits a clock-in time to the controller. Similarly, upon completion of the task and leaving the job location, the clock-out time is transmitted to the controller 108. Both the clock-in time and the clock-out time are transmitted to the controller 108 via the communication network 102. Thus, the total time spent at the job site can be determined by calculating the difference between the clock-in time and the clock-out time. Clock-in and clock-out functions can be automated as in FIG. 4 or manually entered by the user as they enter and leave the job location.

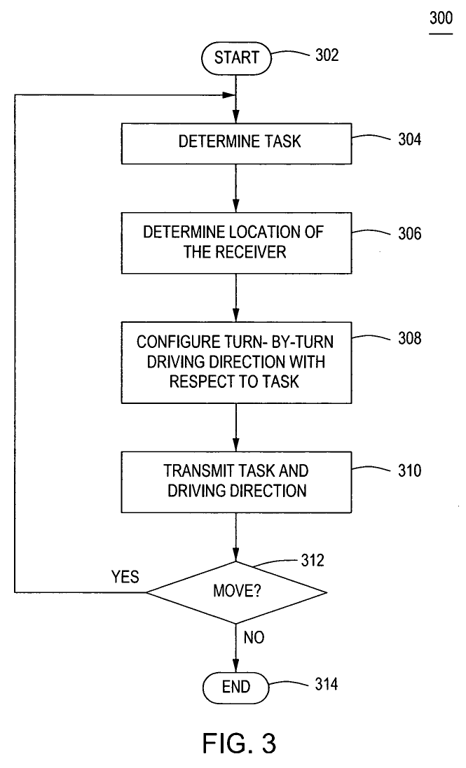

FIG. 3 is a flowchart of a method 300 for generating and sending turn-by-turn task related instructions to a receiver, according to an exemplary embodiment of the present invention. The method 300 starts at step 302 and proceeds to step 304. At step 304, a task is determined for the user to perform. The task assignment may be performed based on the user's expertise, their proximity to the location where the task is to be performed, or any other selection criteria. With every task sent to a user, the user receives turn-by-turn instructions to take the user to the job site to perform the task. At step 306, the location of the receiver is determined using a location provided by the receiver. At step 310, the turn-by-turn driving direction is configured based upon the present location of the receiver and the location of where the task is to be performed. At step 312, the task and directions are transmitted to the receiver. Generally, the method 300 could end at this step after sending the task and directions. Alternatively, a plurality of tasks and directions could be sent to the receiver. As such, at step 314, the method 300 queries if more tasks are to be processed. If more tasks are to be processed, the method proceeds from step 314 to step 304 to generate and send another task and directions. Otherwise, the method 300 ends at step 316. As such, the method 300 may be performed for one task at a time or for a set of tasks. The method 300 may be executed for each receiver such that all the receivers receive at least one task and directions. As tasks are completed, a new task and directions can be sent to the receivers. Task completion is determined through an automated or manual clock-out function described with respect to FIG. 4.

FIG. 4 is a flowchart of a method 400 for determining the status of a receiver, according to an exemplary embodiment of the present invention. The method 400 starts at step 402 and proceeds to step 404. At step 404, a receiver is located either through a database of receiver locations (i.e., the receiver reports a position that is stored in the controller) or the controller requests the location from the receiver. At step 406, the task(s) associated with the user of the receiver are determined. At step 408, the location(s) associated with the task(s) is determined. If the receiver is within the premises of a task/location (or a specific radius there from), the method 400 proceeds to step 412, wherein the status is determined to be clocked-in. Otherwise, the method 400 proceeds to step 414, wherein the status is determine to be clocked-out. At step 416, the status is archived and/or reported. A step 418, the method 400 determines whether the receiver changed location. If the receiver changed location, the method 400 proceeds to step 404. Alternatively, rather than test for location changes, the method 400 may be executed periodically to determine the status of one or more receivers, e.g., every 15 minutes. If the receiver has not changed location, the method 400 determines if there are more receivers. If there are more receivers, the method 400 proceeds to step 404. If there are not more receivers, the method 400 proceeds to step 422. The method 400 ends at step 422.

In various embodiments of the invention, the status determination method 400 can be operated in conjunction with the task-based direction method 300 such that a user is provided a task with instructions and, when they arrive at the job site, the user is automatically clocked-in. Upon leaving the job site, the user is automatically clocked-out and, then, a new task and directions are presented. Alternatively, the clock-in, clock-out function can be manual, e.g., select a particular key on the receiver to indicate clock-in or clock-out.

As one practical example, a plumbing services company may assign a plumbing task to a plumber via the controller. Once the plumber's current location is determined a task can be assigned based on proximity to the task, expertise of the plumber, or some other criteria. The selected task and the turn-by-turn directions to the location of the task can be sent to the plumber's receiver, e.g., cell phone, personal digital assistant, and the like. When the plumber arrives at the job site to perform the task, they may be automatically clocked-in or may manually clock-in. Upon finishing the task and leaving the job site, the plumber is automatically clocked-out or manually clocks-out. Once clocked-out, a new task and directions may be sent, unless a plurality of tasks and directions were sent initially (e.g., a day's schedule) to the plumber's receiver. The controller may adapt scheduled tasks based on completion time and the assignment of new tasks.

In the foregoing specification, specific embodiments of the present invention have been described. However, one of ordinary skill in the art will appreciate that various modifications and changes can be made without departing from the spirit and scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

While the foregoing is directed to embodiments of the present invention, other and further embodiments of the invention may be devised without departing from the basic scope thereof.

What is claimed is:

1. An apparatus for providing task related navigation, comprising:
a controller for determining a task to be performed by a user and generating turn-by-turn travel information related to the task; and
at least one receiver, coupled to the controller, for receiving the task and related turn-by-turn directions to enable the user to travel using the turn-by-turn travel information to a location to perform the task.

2. The apparatus of claim 1 wherein the controller comprises at least one task list and transmits at least one task from the at least one task list to the at least one receiver.

3. The apparatus of claim 1 wherein the controller determines a location of the at least one receiver.

4. The apparatus of claim 3 wherein the controller determines the task based on the location of the at least one receiver.

5. The apparatus of claim 1 wherein the at least one receiver comprises a GNSS receiver for determining a location of the receiver.

6. A method for providing task related navigation comprising:
determining a task;
determining a present location of a receiver associated with a user to perform the task;
generating turn-by-turn travel information related to the task, where the turn-by-turn travel information indicates a path from the present location of the receiver to a location at which the task is to be performed; and
transmitting the task and the turn-by-turn travel information to the receiver.

7. The method of claim 6 wherein the task determining comprises utilizing a criteria to select a task for a particular user.

8. The method of claim 6 wherein the receiver present location determining comprises requesting the present location from the receiver.

9. The method of claim 8 wherein the receiver utilizes a GNSS receiver to determine the present location.

10. The method of claim 5 further comprising:
determining a current location of the receiver; and
determining a status of the receiver depending upon the current location.

11. The method of claim 10 wherein the status identifies whether the receiver has arrived at the location at which the task is to be performed.

12. The method of claim 11 wherein, if the receiver has arrived, clocking-in the user.

13. The method of claim 12 wherein, if the receiver is deemed to leave the location at which the task is to be performed, clocking-out the user.

14. A method for determining a clock-in and clock-out time comprising:
determining a location of a receiver that is associated with a user; and
if the location is proximate a task location where the user is to perform a task, clocking-in the user to begin tracking an amount of time the user performs the task.

15. The method of claim 14 further comprising:
monitoring the location of the receiver; and
when the location is no longer proximate the task location where the user is performing the task, clocking-out the user to cease tracking an amount of time the user performs the task.

16. The method of claim 14 further comprising:
determining the task;
determining turn-by-turn travel information for a path from a present location of the receiver to the location where the task is to be performed.

17. The method of claim 16 wherein the task determining and turn-by-turn travel information determining steps are performed remote from the receiver and are communicated to the receiver via a communications network.
